(19) United States
(12) Patent Application Publication
(10) Pub. No.: US 2020/0224683 A1
(43) Pub. Date: Jul. 16, 2020

(54) Hydraulic Actuator

(71) Applicant: CNH Industrial America LLC, New Holland, PA (US)

(72) Inventors: Launy Luckmann, Sønderborg (DK); Lukas Gröne, Oeversee (DE)

(21) Appl. No.: 16/631,162

(22) PCT Filed: Jul. 10, 2018
(86) PCT No.: PCT/EP2018/068643

§ 371 Date: Jan. 14, 2020

(30) Foreign Application Priority Data
Jul. 14, 2017 (BE) 2017/5503

(51) Int. Cl. F15B 15/14; E01H 5/06

(52) U.S. Cl. CPC F15B 15/1409; F15B 1/24; E01H 5/06

(57) ABSTRACT

A hydraulic actuator including a barrel, a plunger piston, and a loose piston. The plunger piston is arranged inside the barrel and at a first axial end thereof includes a piston end element. The loose piston is arranged within the barrel, thereby partitioning the interior of the barrel into a first compartment and a second compartment. The piston end element partitions the interior of the barrel into a second and a third compartment. The hydraulic actuator includes a first opening for providing a hydraulic pressure into the first compartment, and a second opening for providing a hydraulic pressure into the second compartment or into the third compartment. The hydraulic actuator is configured such that the second compartment is in fluid connection with the third compartment.

### FIELD OF THE INVENTION

The present invention generally relates to the field of hydraulic suspensions. More specifically the present invention relates in a first aspect to a hydraulic actuator. In a second aspect the present invention relates to a hydraulic circuit comprising a hydraulic actuator according to the first aspect of the invention. In a third aspect the present invention relates to an apparatus comprising an actuator according to the first aspect of the present invention. In a fourth aspect the present invention relates to a use of a hydraulic actuator according to the first aspect or of a hydraulic circuit according to the second aspect of the present invention for suspending a movable part to a stationary part in an apparatus.

### BACKGROUND OF THE INVENTION

In various types of apparatuses for use in the field of construction, agriculture and manufacturing machinery etc., hydraulic actuators have found widespread use.

Hydraulic actuators provide a unidirectional force, either by expansion or by contraction, and allow for exerting great forces in a very reliable manner, taking up only a minimum of space and comprising a minimum of components.

A typical hydraulic actuator comprises a barrel having a closed end (cap end) and an opposite open end (head end). A piston is arranged in the interior of the barrel and the piston is connected to a piston rod which extends in an axial direction out of the barrel. A sealing between the piston rod and the open axial head end of the barrel provides a tight seal between these entities.

Providing a hydraulic pressure to the interior of the barrel at the cap end thereof results in an expansive reaction of the piston, whereas providing a hydraulic pressure to the interior of the barrel at the head end thereof results in a contraction reaction of the piston.

In this way, connecting a hydraulic actuator to a hydraulic pump and one or more hydraulic valves allows one to control a hydraulic cylinder in such a way that an activation one or more of the hydraulic valves implies a reactive force in the hydraulic actuator, either in an expansive way or by contraction.

In some suspension applications where a movable entity is being suspended in a stationary part so as to be able to be raised and lowered by means of a hydraulic actuator, between a lowered position and a raised position, it is desirably that the moveably entity in its lowered position is configured to be in a “floating” mode in the sense that within a vertical working range the movable entity is allowed, by exerting a force thereto, to be displaced a small distance in a vertical direction.

Conventionally such floating suspensions have been provided for suspending a movable entity in a stationary part by balancing the gravitational force acting on the movable entity on the one hand with a spring force, provided by a mechanical spring, and on the other hand acting in the opposite direction. Thereby the effective weight of the moving entity is lowered.

Such type of floating suspension provides for allowing the movable entity to “float” on the ground, such as by being slit over the ground, while still allowing the movable entity to be displaced a certain distance upward and downward in a vertical direction.

Examples of use of such floating suspensions are in windrowers and windrow inverters where a movable entity responsible for handling grass or straw being spread in an agricultural field, is being slit over the surface of the ground while being suspended in a floating suspension. Another example is the suspension of a snow plough suspended at the front of a truck. Here, the snow plough is pushed forward while scraping the asphalt of a road or a street.

Although such types of floating suspension have proved useful they nevertheless suffer from certain disadvantages.

One such disadvantage is caused by the hysteresis effect of the hydraulic actuator used in such systems resulting in some degree of “sluggishness” of the movement of the piston in relation to attaining a “correct” equalization position of the piston, when being balanced between the force exerted by gravity on the one hand and the counteracting force exerted by the spring on the other hand.

The presence of sluggishness in the suspension has the consequence that a certain amount of inaccuracy as to the vertical position of the movable entity of the suspension will result. That is, when the movable entity returns to a lower rest position after having been allowed to move up and down in a vertical direction, that rest position will vary from one cycle of movements to the next.

Hence, the rest position of the movable entity of the suspension which rest position is being balanced between the forces exerted by gravity on the one hand and the counteracting force exerted by the spring on the other hand is not an exact or constant position. Rather, this rest position of the movable entity varies from one cycle to the next.

This sluggishness is caused by the rather high degree of friction encountered in the sealings which seal the movable piston and its associated rod against the barrel of the hydraulic actuator.

Furthermore, the spring itself, which is responsible for providing the force acting opposite to the force of gravity, will contribute to hysteresis in the suspension.

Therefore, in the prior art suspension mechanisms operated in a floatation mode, where a movable part is being suspended in a stationary part by a hydraulic actuator, the movable part will not be able to return to the same constant rest position after having been subjected to movement.

This phenomenon accordingly implies difficulties in adjusting the settings of such an apparatus, and ultimately has the consequence that a non-optimum work quality is being obtained by that working unit in a working situation.

Accordingly a need persists for a hydraulic actuator and an apparatus which overcome the disadvantages of the prior art as set forth above.

It is an objective of the present invention to provide a hydraulic actuator, a hydraulic circuit, apparatuses and uses thereof which alleviate or even eliminate the disadvantages of the prior art as outlined above.

### BRIEF DESCRIPTION OF THE INVENTION

This objective is fulfilled by the present invention in its first, second, third and fourth aspect respectively.

Accordingly, the present invention relates in a first aspect to a hydraulic actuator comprising:
a barrel comprising a closed axial cap end and an open axial head end;
a plunger piston comprising a first axial end and a second axial end;
a loose piston having a first axial surface and a second axial surface;
   wherein said plunger piston is being arranged in the interior of said barrel at the open axial head end thereof in such a way that said first axial end of said plunger piston is being arranged within the interior of said barrel and in such a way that said second axial end of said plunger piston extends axially out of said open axial head end of said barrel;
   wherein said plunger piston at said first axial end thereof comprises a piston end element having a first surface pointing towards the closed axial cap end of said barrel and a second surface pointing towards the open head end of said barrel;
   wherein said piston end element is having dimensions in a direction perpendicular to an axial direction of said plunger piston which correspond to the internal dimensions, in the same direction, of said barrel;
   wherein said loose piston is being arranged within said interior of said barrel between said closed axial cap end of said barrel and said first surface of said piston end element;
   thereby defining a first compartment and a second compartment in the interior of said barrel; wherein said first compartment being confined between said axial cap end of said barrel and said first axial surface of said loose piston; and wherein said second compartment being confined between said second axial surface of said loose piston and said first surface of said piston end element;
   wherein said interior of said barrel comprises a third compartment; said third compartment being confined between said second surface of said piston end element and said open axial head end of said barrel;
   wherein said barrel at said axial cap end thereof comprises a first opening for providing a hydraulic pressure into said first compartment of said interior of said barrel; and
   wherein said hydraulic actuator comprises a second opening for providing a hydraulic pressure into said second compartment and/or into said third compartment of said interior of said barrel;
   wherein said hydraulic actuator is configured in such a way that said second compartment of the interior of said barrel is being in fluid connection with said third compartment of the interior of said barrel.

In a second aspect the present invention relates to a hydraulic circuit comprising:
a hydraulic actuator according to the first aspect of the present invention;
a hydraulic pump;
a reservoir of hydraulic liquid;
one or more hydraulic valves;
a plurality of hydraulic hoses.

In a third aspect the present invention relates to an apparatus comprising a stationary part and a movable part, wherein said movable part is being mechanically connected to said stationary part via a suspension;

wherein said suspension comprises an actuator according to the first aspect of the present invention;
wherein one axial end of said actuator is being connected to said stationary part of said apparatus; and wherein an opposite axial part of said actuator is being connected to said moveable part of said apparatus.

Finally, in a fourth aspect the present invention relates to a use of a hydraulic actuator according to the first aspect of the present invention; or of a hydraulic circuit according to the second aspect of the present invention for suspending a movable part to a stationary part in an apparatus.

The present invention in its various aspects provides for an improved suspension having reduced internal friction and accordingly less hysteresis when the hydraulic actuator is being configured in a flotation mode in which a static hydraulic pressure is supplied to the second or the third compartment of the interior of the barrel by having a hydraulic accumulator in fluid connection with this third compartment, thereby allowing the actuator to automatically counteract any external force exerting on the plunger piston in a direction into the barrel.

Thereby an improved work quality is obtained when the hydraulic actuator of the present invention is being used in a suspension for suspending a working unit to be dragged or slit over the ground in a working situation.

Moreover, when used in an apparatus for suspending, via lift, a movable entity in relation to a stationary part the hydraulic actuator of the present invention allows obtaining an essentially constant load or constant effective weight of that movable entity over a wide range of working heights thereof.

Furthermore, the present invention in its various aspects provides for reduced weight of a suspension by utilizing the inventive hydraulic actuator.

### BRIEF DESCRIPTION OF THE FIGURES

FIG. 1 is a perspective view illustrating a hydraulic actuator according to the first aspect the present invention.

FIG. 2 is a cross-sectional view illustrating one embodiment of a hydraulic actuator according to the first aspect to the present invention.

FIG. 3 is a cross-sectional view illustrating a hydraulic actuator according to the first aspect of present invention equipped with a hydraulic accumulator.

FIG. 4 is a schematic view illustrating a hydraulic circuit according to a second aspect of the present invention.

FIG. 5 is a schematic view illustrating an apparatus according to the third aspect of the present invention.

### DETAILED DESCRIPTION OF THE INVENTION

In a first aspect the present invention relates to a hydraulic actuator comprising:
a barrel comprising a closed axial cap end and an open axial head end;
a plunger piston comprising a first axial end and a second axial end;
a loose piston having a first axial surface and a second axial surface;
   wherein said plunger piston is being arranged in the interior of said barrel at the open axial head end thereof in such a way that said first axial end of said plunger piston is being arranged within the interior of said barrel and in such a way that said second axial end of said plunger piston extends axially out of said open axial head end of said barrel;
   wherein said plunger piston at said first axial end thereof comprises a piston end element having a first surface pointing towards the closed axial cap end of said barrel and a second surface pointing towards the open head end of said barrel;
   wherein said piston end element is having dimensions in a direction perpendicular to an axial direction of said plunger piston which correspond to the internal dimensions, in the same direction, of said barrel;
   wherein said loose piston is being arranged within said interior of said barrel between said closed axial cap end of said barrel and said first surface of said piston end element;
   thereby defining a first compartment and a second compartment in the interior of said barrel; wherein said first compartment being confined between said axial cap end of said barrel and said first axial surface of said loose piston; and wherein said second compartment being confined between said second axial surface of said loose piston and said first surface of said piston end element;
   wherein said interior of said barrel comprises a third compartment; said third compartment being confined between said second surface of said piston end element and said open axial head end of said barrel;
   wherein said barrel at said axial cap end thereof comprises a first opening for providing a hydraulic pressure into said first compartment of said interior of said barrel; and
   wherein said hydraulic actuator comprises a second opening for providing a hydraulic pressure into said second compartment and/or into said third compartment of said interior of said barrel;
   wherein said hydraulic actuator is configured in such a way that said second compartment of the interior of said barrel is being in fluid connection with said third compartment of the interior of said barrel.

By providing the hydraulic actuator according to the first aspect of the present invention with a loose piston which partitions the interior of the barrel of the hydraulic actuator into a first compartment and a second compartment; and by providing the plunger piston of the hydraulic actuator according to the first aspect of the present invention with a piston end element partitioning the interior of the barrel of the actuator into that second compartment and a third compartment, wherein the second compartment and the third compartment are in fluid connection, it is possible to apply a dynamic hydraulic pressure into the first compartment of the hydraulic actuator and to apply a static hydraulic pressure which is in fluid connection with a hydraulic accumulator.

This has the advantage that the extension of the plunger piston can be determined by the dynamic pressure applied to the first compartment and that once an extension of the plunger piston has been settled, a spring effect of the plunger piston can be attained by applying a static hydraulic pressure to the second or the third compartment of the interior of the barrel of the hydraulic actuator; the spring action being provided by a hydraulic accumulator which is being in fluid connection with the second compartment or the third compartment of the interior of the barrel of the hydraulic actuator. The real advantage of the inventive hydraulic actuator is that a considerably lower sluggishness as caused by friction and hysteresis is attained.

In the present description and in the appended claims the term “stationary part” of an apparatus shall be construed to mean a part of an apparatus which during use is configured for being fixed to a an entity and which, during use, is fixed or stationary in relation to that entity.

In the present description and in the appended claims the term “movable part” of an apparatus shall be construed to mean a part of an apparatus which during use is not directly fixed to a stationary part of that apparatus but which, during use, is configured by being suspended, to be movable in relation to that stationary part of that entity.

In the present description and in the appended claims the term “expansion of a hydraulic actuator” shall be construed to mean that the plunger piston of said hydraulic actuator is performing a displacement, relative to said barrel, in a direction out of said barrel.

In the present description and in the appended claims the term “contraction of a hydraulic actuator” shall be construed to mean that the plunger piston of said hydraulic actuator is performing a displacement, relative to said barrel, in a direction into said barrel.

It should be noted that it is understood that as it is customary with prior art hydraulic actuators comprising a plunger piston, also the hydraulic actuator of the first aspect in all its embodiments of the present invention comprises an end closure arranged in the open axial head end of the barrel for sealing the space between the barrel and the cylindrical surface of the plunger piston, or part thereof. Such end closure is securing that no hydraulic fluid will leak out of the open head end of the barrel.

In one embodiment of the first aspect of the present invention said plunger piston is comprising a cylindrical element between said second surface of said piston end element and said second axial end thereof, wherein the dimension of said cylindrical element in a direction perpendicular to an axial direction of said plunger piston is smaller than the dimension, in the same direction, of said piston end element.

Such a design of the plunger piston ensures a certain and/or desirable volume of the third compartment of the interior of the barrel.

In one embodiment of the first aspect of the present invention said second opening is arranged at an axial head end of the barrel, thereby allowing providing a hydraulic pressure into said third compartment of said interior of said barrel.

Such an arrangement of the second opening is advantageous because it is stationary in relation to the barrel. Furthermore, this position of the second opening for providing hydraulic fluid into the interior of the barrel has shown to provide the least degree of hysteresis in the hydraulic system comprising the inventive hydraulic actuator.

In another embodiment of the first aspect of the present invention said second opening is arranged at said second axial end of said plunger piston and furthermore said plunger piston is provided with a channel connecting said second opening with said first surface of said piston end element, thereby allowing providing a hydraulic pressure into said interior of said barrel via said plunger piston.

Such a location of the second opening for providing a hydraulic pressure into said interior of said barrel may in certain applications be advantageous in relation to inter alia space limiting considerations.

In one embodiment of the first aspect of the present invention said hydraulic actuator further comprises a first connector for connecting a hydraulic hose, wherein said first connector is being arranged in said first opening, thereby allowing application of a first hydraulic pressure into said first compartment of the interior of said barrel; and/or further comprising a second connector for connecting a hydraulic hose, wherein said second connector is being arranged in said second opening, thereby allowing application of a second hydraulic pressure into said second compartment and/or said third compartment of the interior of said barrel.

Providing the openings for hydraulic pressure of the hydraulic actuator with connectors makes it easy to hook up the hydraulic actuator in a hydraulic circuit.

In one embodiment of the first aspect of the present invention said open axial head end of said barrel comprises one or more seals, sealing the space between said barrel and said plunger piston.

Such seals ensure that no leaking of hydraulic fluid will take place at the open axial head end of the barrel.

In one embodiment of the first aspect of the present invention said first axial end of said plunger piston is provided with one or more guides, guiding its displacement along the interior surface of said barrel.

Such guides will ensure that the piston end element will be concentrically arranged in the interior of the barrel.

In one embodiment of the first aspect of the present invention said loose piston is configured in a way, inter alia by adaptation of its dimensions, so as to ensure that there is no fluid connection between said first compartment and said second compartment of the interior of said interior of said barrel.

Ensuring that the is no fluid connection between said first compartment and said second compartment of the interior of said interior of said barrel will allow concurrent use of the hydraulic actuator as an actuator on the one hand and a spring means on the other hand.

In one embodiment of the first aspect of the present invention said hydraulic actuator further comprises a hydraulic accumulator, wherein said hydraulic accumulator is being in fluid connection with said second compartment or said third compartment of the interior of said barrel.

In one embodiment of this embodiment said hydraulic accumulator is being spring loaded or being loaded via compressed gas.

In one embodiment of the first aspect of the present invention said hydraulic accumulator is being in fluid connection with said second compartment or said third compartment of the interior of said barrel via said second opening for hydraulic pressure.

Providing the hydraulic actuator with a hydraulic accumulator makes it possible to attain a spring effect of the hydraulic accumulator. It should be noted that the hydraulic accumulator in the general case may be arranged anywhere as long as it is in fluid connection with the hydraulic pressure being applied to the second or the third compartment of the barrel. However, the closer the accumulator is arranged to the barrel itself, the less hysteresis is encountered for the hydraulic circuit comprising such hydraulic actuator and hydraulic accumulator.

In one embodiment of the first aspect of the present invention said fluid connectivity between said second compartment and said third compartment of said interior of said barrel is provided by one or more channels arranged at said piston end element; such as in the form of channels extending between said first surface of said piston end element and a cylindrical surface of said plunger piston; and/or in the form of channels being arranged at a circumference of said piston end element, and connecting said second compartment with said third compartment.

These designs of the channels connecting the second compartment with the third compartment have shown to provide adequate fluid connectivity between these two compartments for the intended purpose.

In one embodiment of the first aspect of the present invention the area of a projection of said first surface of said piston end element onto a plane perpendicular to an axial direction of said plunger piston is being greater than the area of a projection of said second surface of said piston end element onto the same plane.

Hereby is ensured that application of hydraulic pressure into the second compartment or the third compartment of the interior of the barrel, which due to the fluid connectivity between the second compartment and the third compartment of the interior of the barrel will lead to the same hydraulic pressure in these two compartments, nevertheless will result in an expansion of the plunger piston in such a situation because the hydraulic pressure in the second compartment will act on a larger area of the piston end element, compared to the situation in respect of the third compartment.

In one embodiment of the first aspect of the present invention said actuator, at its two opposite axial ends, comprises connecting means for fixing said actuator, at said two opposite axial ends thereof, to two different entities.

Such connection means allows easy mounting of the hydraulic actuator in an apparatus.

In one embodiment of the first aspect of the present invention the interior cross-section of said barrel is being circular; or being a polygon, such as rectangular, for example a square; or being triangular, hexagonal or octagonal.

In a second aspect the present invention relates to a hydraulic circuit comprising:
a hydraulic actuator according to the first aspect of the present invention;
a hydraulic pump;
a reservoir of hydraulic liquid;
one or more hydraulic valves;
a plurality of hydraulic hoses.

In one embodiment of the second aspect of the present invention the hydraulic circuit further comprises a hydraulic accumulator which is being in fluid connection with said second compartment or said third compartment of said interior of said barrel of said hydraulic actuator;

wherein said hydraulic actuator, said hydraulic pump, said reservoir of hydraulic liquid, said one or more hydraulic valves are connected with hydraulic hoses in a way that allows:
i) dynamically application of a hydraulic pressure to said first compartment of said barrel, thereby displacing said loose piston up against said first surface of said piston end element and subsequently effecting an expansion of said plunger piston relative to said barrel;
ii) dynamically application of a hydraulic pressure to said second or third compartment of said barrel, thereby allowing hydraulic fluid to flow from said third or second compartment into said second or third compartment of said interior of said barrel; thereby displacing said loose piston towards the axial cap end of said barrel; and thereby effecting an expansion of said plunger piston, relative to said barrel,
iii) upholding a static hydraulic pressure in said second or third compartment of said barrel and thereby, by virtue of said hydraulic accumulator, provide a force to said plunger piston, in an axial direction out of said barrel.

As outlined in a previous section above such a hydraulic circuit provides for a situation in which it is possible to apply a dynamic hydraulic pressure into the first compartment of the hydraulic actuator and to apply a static hydraulic pressure into said second or said third compartment, which are in fluid connection with a hydraulic accumulator, thereby attaining an expansion of the hydraulic actuator on the one hand and a spring effect thereof on the other hand.

In a third aspect the present invention relates to an apparatus comprising a stationary part and a movable part, wherein said movable part is being mechanically connected to said stationary part via a suspension;

wherein said suspension comprises an actuator according to the first aspect of the present invention;
wherein one axial end of said actuator is being connected to said stationary part of said apparatus; and wherein an opposite axial part of said actuator is being connected to said moveable part of said apparatus.

Accordingly, such an apparatus can be configured for providing a lift to the movable part, relative to the stationary part by providing a dynamic hydraulic pressure into the first compartment of the hydraulic actuator, and once a predetermined lift height has been set, also allow the movable part to bounce in an up and down direction commensurate with the force acting thereon. This spring or bouncing effect is attained by application of a static hydraulic pressure being supplied to the second or the third compartment of the interior of the barrel, and is attained by connecting a hydraulic accumulator to the hydraulic pressure being supplied to the second or the third compartment of the interior of the barrel.

In one embodiment of the third aspect of the present invention said apparatus comprises a hydraulic circuit according to the second aspect of the present invention.

Including such a hydraulic circuit provides full control of the movement of the movable part, relative to the stationary part of the apparatus.

In one embodiment of the third aspect of the present invention said stationary part and said movable part are being configured, in relation to each other, in such a way that an expansion of said hydraulic actuator corresponds to a lift, against the action of gravity, of said movable part in relation to said stationary part.

In one embodiment of the third aspect of the present invention said apparatus comprises a working unit which is being mechanically connected to said movable part.

In one embodiment of the third aspect of the present invention said apparatus is selected from the group comprising snow ploughs for being suspended at the front of a truck; and windrowers, and windrow inverters.

In such uses it is of paramount importance for the quality of the work being performed that the suspension of the apparatus exhibits a minimum of hysteresis. Such low degree of hysteresis is attained by using the hydraulic actuator according to the first aspect in such apparatuses.

In one embodiment of the third aspect of the present invention said apparatus is complying with the proviso that said apparatus does not comprise a cutting unit for a mower.

In a fourth aspect the present invention relates to a use of a hydraulic actuator according to the first aspect of the present invention; or of a hydraulic circuit according to the second aspect of the present invention for suspending a movable part to a stationary part in an apparatus.

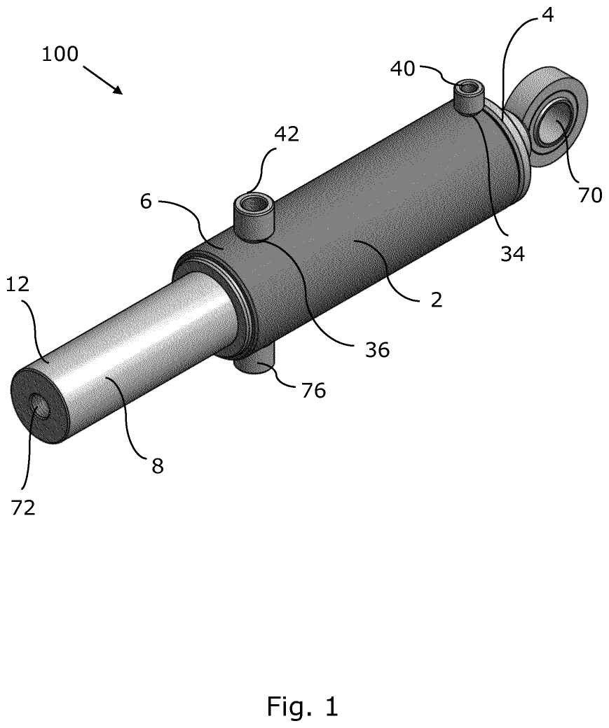

Referring now to the figures for better illustrating the present invention in its various aspects, FIG. 1 is a perspective view showing a hydraulic actuator according to the first aspect of the present invention.

FIG. 1 shows the external parts of a hydraulic actuator 100 comprising a barrel 2. The barrel 2 is having a closed axial cap end 4 and an open axial head end 6. In the open axial head end 6 is arranged a plunger piston 8. The plunger piston 8 comprises a first axial end 10 which is accommodated in the interior of the barrel 2 and accordingly not visible in FIG. 1. The plunger piston 8 also comprises a second axial end 12 extending axially out of said open axial head end 6 of the barrel 2.

The barrel at the axial cap end 4 thereof comprises a first opening 34 for providing a hydraulic pressure into a first compartment of said interior of the barrel. This opening has been provided with a first connector 40 for a hydraulic hose.

In the opposite axial head end 6, the barrel comprises a second opening 36 for providing a hydraulic pressure into the third compartment of the interior of the barrel. This opening has been provided with a second connector 42 for a hydraulic hose.

In fact, in the embodiment illustrated in FIG. 1 there are provided two connectors 42 and 76 arranged at the open head end of the barrel 2.

In the two opposite ends of the hydraulic actuator connecting means 70,72 have been provided for allowing connection of these two opposite ends to separate entities.

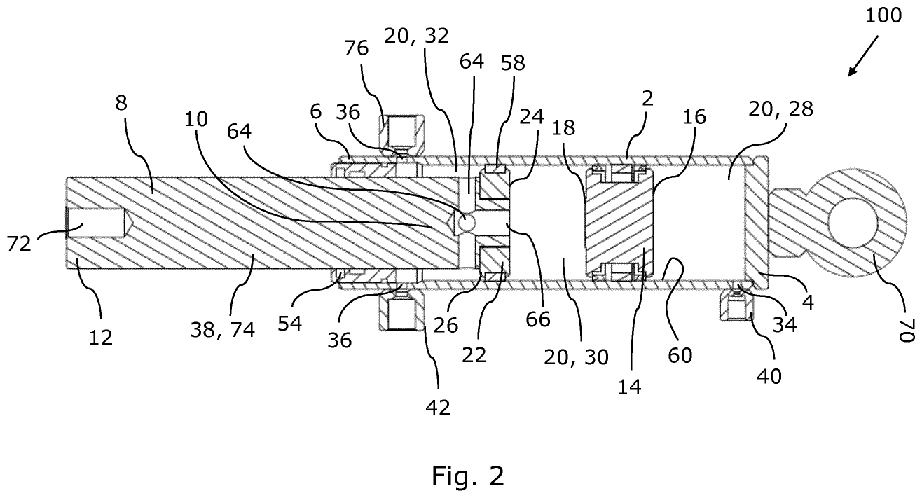

FIG. 2 is a cross-sectional view illustrating one embodiment of a hydraulic actuator according to the first aspect to the present invention.

FIG. 2 illustrates the interior structure of the hydraulic actuator 100. Again it is seen that the hydraulic actuator comprises a barrel 2 having a closed axial cap end 4 and an open axial head end 6. The plunger piston 8 is arranged in the interior 20 of the barrel which accommodates the first axial end 10 of the plunger piston 8. The first axial end 10 of the plunger piston 8 comprises a piston end element 22.

The piston end element 22 comprises a first surface 24 pointing towards the closed axial cap end 4 of the barrel and a second surface 26 pointing towards the head end 6 of the barrel.

The piston end element 22 is having dimensions in a direction perpendicular to an axial direction of the plunger piston 8 which correspond to the internal dimension, in the same direction, of the barrel. The piston end element 22 has been provided with a guide 58.

It is seen in FIG. 2 that a loose piston 14 has been arranged within the interior 20 of the barrel 2 between the closed axial cap end 4 of the barrel and the first surface 24 of the piston end element 22; thereby defining a first compartment 28 and a second compartment 30 in the interior 20 of the barrel.

The first compartment 28 is being confined between the axial cap end 4 of the barrel 2 and the first axial surface 16 of the loose piston 14.

The second compartment 30 is being confined between the second axial surface 18 of the loose piston 14 and the first surface 24 of the piston end element 22.

Moreover, the interior 20 of the barrel 2 also comprises a third compartment 32.

The third compartment 32 is being confined between the second surface 26 of the piston end element 22 and said open axial head end 6 of said barrel 2.

The division of the interior 20 of the barrel 2 into three compartments allows for either applying a hydraulic pressure to the first compartment 28 of the interior via the opening 34 as illustrated in FIG. 2, thereby providing an expansion of the plunger piston 8 out of the barrel 2; or alternatively to apply a hydraulic pressure to the second compartment 30 or the third compartment 32 of the interior 20 of the barrel 2 via the opening 36 as illustrated in FIG. 1.

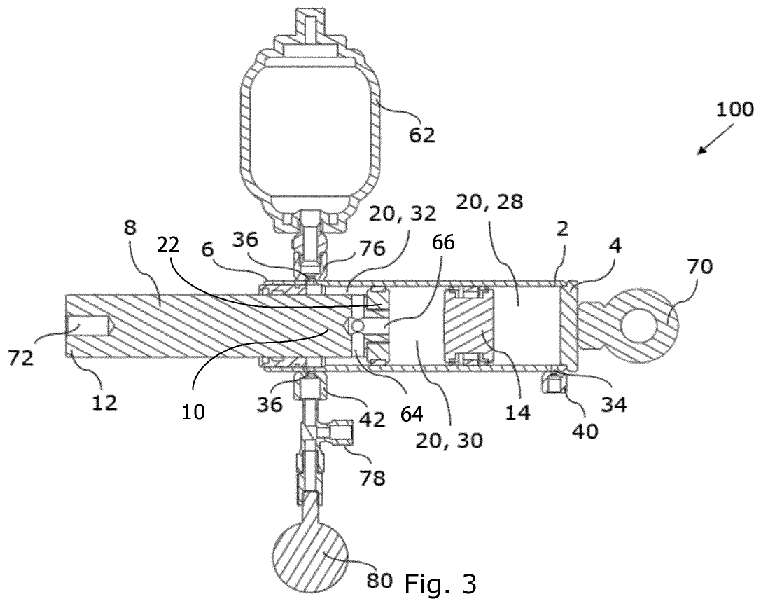

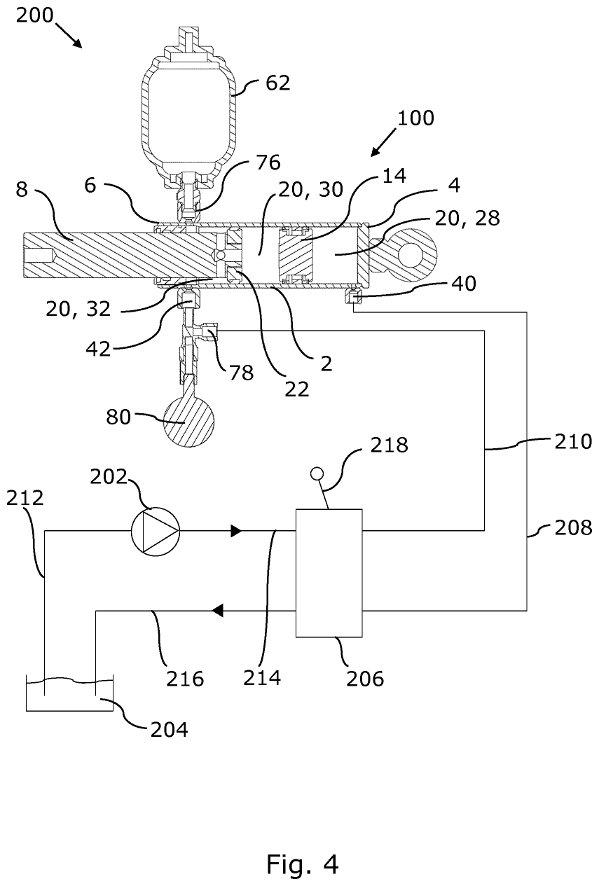

These different working modes are explained in more detail with reference to FIGS. 3 and 4 below.

It is also seen that the piston end element 22, in a direction perpendicular to the axial direction, is having a maximum dimension which is greater than the maximum dimension, in the same direction, of a remainder of the plunger piston 8, which comprises a cylindrical element 38 having a surface 74. Hereby a desired volume of the third compartment 32 in the interior 20 of the barrel 2 is ensured.

Besides, the piston end element 22 may also act as an end stop preventing the plunger piston to be displaced all the way out of the barrel 2 in an expanded state.

The loose piston 14 is loose in the sense that it is allowed to slit along the axial direction of the first and second compartment 28,30 of the interior 20 of the barrel 2, depending on which side thereof is subjected to the highest hydraulic pressure. The loose piston 14 allows for separating a hydraulic pressure in the first compartment 28 of the interior 20 of the barrel from a hydraulic pressure being present in the second compartment 30 of the interior 20 of the barrel 2.

The hydraulic actuator is configured in such a way that the second compartment 30 of the interior 20 of the barrel is being in fluid connection with the third compartment 32 of the interior 20 of said barrel 2. This has been accomplished by providing the plunger piston 8 and the piston end element 22 of the plunger piston 8 with channels 64,66 which connect the second compartment 30 of the interior 20 of the barrel 2 with the third compartment 32 of the interior 20 of the barrel 2.

The channels 64,66 extend between the first surface 24 of the piston end element 22 and a cylindrical surface 74 of the plunger piston.

These channels 64,66 allow hydraulic fluid to flow from the third compartment 32 of the interior 20 of the barrel 2 to the second compartment 30 of the interior 20 of the barrel, and vice versa.

Alternatively, channels may be arranged at the perimeter of the piston end element 22 and connecting the second compartment 30 with the third compartment 32 of the interior 20 of the barrel 2.

Guide 58 provides a guide for the displacement in the interior of the barrel of the plunger piston at the piston end element thereof.

In the configuration illustrated in FIG. 2 the hydraulic actuator 100 is in a mode in which hydraulic pressure has been applied to the third compartment 32 of the interior 20 of the barrel 2 and in which the hydraulic pressure in the first compartment is in a flotation mode. This has caused hydraulic fluid to flow via channels 64,66 from the third compartment 32 of the interior 20 into the second compartment 30 of the interior 20. This in turn has forced to loose piston 14 to start moving down to the cap end 4 of the barrel.

Further, as the area of the first surface 24 of the piston end element 22 is greater than the area of the second surface 26 of the piston end element 22, increasing the hydraulic pressure in the third compartment and thereby also in the second compartment (due to channels 64,66) will effect an expansion of the plunger piston 8 in a direction out of the barrel.

In case the third compartment 32 of the interior 20 of the barrel is connected to a hydraulic accumulator, a spring effect will be attained in the sense that, at a given equal and static hydraulic pressure in the second compartment 30 and the third compartment 32, caused by that hydraulic actuator. The spring effect will be provided by the hydraulic accumulator.

In case a force is exerted on the plunger piston 8 in an axial direction into the barrel 2, the hydraulic accumulator, which is in fluid connection with the third compartment 32, will be acting as a spring so that the plunger piston 8 counteracts a displacement of the plunger piston 8 into the barrel by providing a force to the plunger piston 8 in a direction out of the barrel 2.

Such a setup of the inventive hydraulic actuator including a hydraulic accumulator is illustrated in FIG. 3.

FIG. 3 is a cross-sectional view illustrating hydraulic actuator 100 according to the first aspect of present invention equipped with a hydraulic accumulator.

FIG. 3 shows the hydraulic actuator 100 comprising a barrel 2 having an axial cap end 4 and an axial head end 6. A plunger piston 8 is arranged in the interior of the barrel with its first axial end 10 inserted therein and its opposite, second axial end 12 is extending in an axial direction out of the barrel 2.

A first connector 40 for applying a hydraulic pressure to the first compartment 28 of the interior 20 of the barrel is provided near the closed cap end 4 of the barrel 2.

A second connector 42 for applying a hydraulic pressure to the third compartment 32 of the interior 20 of the barrel is provided near the open head end 6 of the barrel 2. This connector 42 is connected to a hydraulic pressure gauge 80 and a connector 78 for a hydraulic hose.

A third connector 76 is provided near the head end 6 of the barrel 2. This connector 76 is connected to a hydraulic accumulator 62 and is being in fluid connection with the third compartment 32 of the interior 20 of the barrel 2.

In FIG. 3 the plunger piston 8 has been displaced a certain distance out of the barrel 2. This has been accomplished by supplying a hydraulic pressure to the connector 40 in the first opening 34 near the cap end 4 of the barrel. This hydraulic pressure will cause the loose piston to be displaced to the left and to push the plunger piston 8 in a direction out of the barrel.

In case in the situation depicted in FIG. 3 the hydraulic pressure applied to the first compartment 28 of the interior 20 of the barrel 2 is in a flotation mode, allowing hydraulic fluid to flow freely in and out of the first compartment via the first opening 34, and in case a hydraulic pressure is applied to connector 78 in order to provide a hydraulic pressure to the third compartment 32 of the interior 20 of the barrel 2, the loose piston will be displaced to the right because an increased hydraulic pressure will cause hydraulic fluid to flow from the third compartment 32 to the second compartment 30 of the interior 20 due to the channels 64,66 and hence this hydraulic pressure in the second compartment 30 will displace the loose piston 14.

By supplying a hydraulic pressure to the connector 42 via connector 78, the hydraulic accumulator 62 will provide a spring effect in the sense that an external force acting on the plunger piston 8 in a direction into the barrel will cause hydraulic fluid being present in the second compartment 30 to flow through the channels 64,66 into the third compartment and further into the hydraulic accumulator 62. The hydraulic accumulator 62 will thereby contain an increased amount of hydraulic fluid and because of this the accumulator 62 responds with a reaction in which the hydraulic pressure being present in that hydraulic accumulator attempts to make hydraulic fluid flow back into the third compartment 32, and into the second compartment 30, which will result in a reactive force attempting to displace the plunger piston out of the barrel 2, thereby counteracting the external force exerted on the plunger piston in a direction into the barrel.

As the hydraulic actuator 100 of the first aspect of the present invention may only necessitate providing the plunger piston 8 with the guide 58 at the circumference of the piston end element and the seal 54 at the head end of the barrel, in contrast to the provision of more seals of the prior art hydraulic actuators, the inventive actuator 100 will in its floatation mode, in which a static hydraulic pressure is provided into the third compartment of the interior 20 of the barrel 2, be prone to much less friction and hence less hysteresis, upon displacement of the plunger piston 8 in relation to the barrel 2 in a working situation.

Accordingly, applying a dynamic hydraulic pressure to the first compartment 28 of the interior 20 of the barrel 2 allows for controlling the extension of displacement of the plunger piston 8 out of the barrel 2 of the hydraulic actuator 100, whereas applying a static hydraulic pressure to the second compartment 30 or third compartment 32 of the interior 20 of the barrel 2 allows for attaining a spring effect of the plunger piston 8 in relation to a force acting thereon.

FIG. 4 is a schematic view illustrating a hydraulic circuit 200 according to a second aspect of the present invention. FIG. 4 shows the hydraulic circuit 200 which comprises a hydraulic actuator 100 according to the first aspect of the present invention.

The hydraulic actuator comprises a barrel 2 in the interior of which is arranged a plunger piston 8 and a loose piston 14. The interior 20 of the barrel 2 is divided into a first compartment 28 and a second compartment 30 and a third compartment 32 as described above. A connector 40 arranged at the closed cap end 4 of the barrel 2 allows application of a hydraulic pressure to the first compartment 28 of the interior 20 of the barrel 2.

Likewise, a connector 42 arranged at the open head end 6 of the barrel 2 thereof allows application of a hydraulic pressure to the third compartment 32 of the interior 20 of the barrel 2. Also, a hydraulic accumulator 62 is in fluid connection with the third compartment 32 of the interior 20 of the barrel 2 via connector 76, and additionally, a hydraulic pressure gauge 80 is connected to the connector 42 thereby allowing monitoring the hydraulic pressure in the third compartment 32 of the interior 20 of the barrel 2.

The hydraulic actuator is being connected to the hydraulic hose 208 for supplying a pressurized hydraulic fluid to the connector 40 and thereby supplying a hydraulic pressure into the first compartment 28 of the interior 20 of the barrel. Furthermore, a hydraulic hose 210 is connected to the connector 42, via connector 78, for supplying a pressurized hydraulic fluid into the third compartment 32 of the interior 20 of the barrel.

The controlling of the hydraulic actuator 100 is brought about by the hydraulic control valve 206 via the lever 218.

A hydraulic pump 202 is being supplied with hydraulic fluid from the reservoir 204 via the hydraulic hose 212. The hydraulic fluid is pressurized in the pump and expelled therefrom to the hydraulic control valve 206 via hydraulic hose 214.

Depending on the position of the lever 218, the hydraulic control valve 206 is able to supply pressurized hydraulic fluid via hose 208 to the connector 40 and thereby into the first compartment 28 of the interior 20 of the barrel 2. This will cause the hydraulic actuator to expand in that the plunger piston 8 will be displaced in a direction out of the barrel 2 of the actuator 100.

In another position of the lever 218 the hydraulic valve is able to supply pressurized hydraulic fluid via hose 210 to the connector 42 via connector 78, and thereby into the third compartment 32 of the interior 20 of the barrel 2. This will effect an increased pressure in the hydraulic accumulator 62 which in turn will effect that the plunger piston 8 will experience a “spring effect” as explained above in the sense that an external force attempting to displace the plunger piston into the barrel 2, will be counteracted by a reaction force, attempting to displace the plunger piston 8 in a direction out of the barrel 2.

The hydraulic hose 216 is a return hose connecting the hydraulic control valve 206 with the reservoir for hydraulic liquid 204.

The control valve 206 may be manually operated or automatically operated.

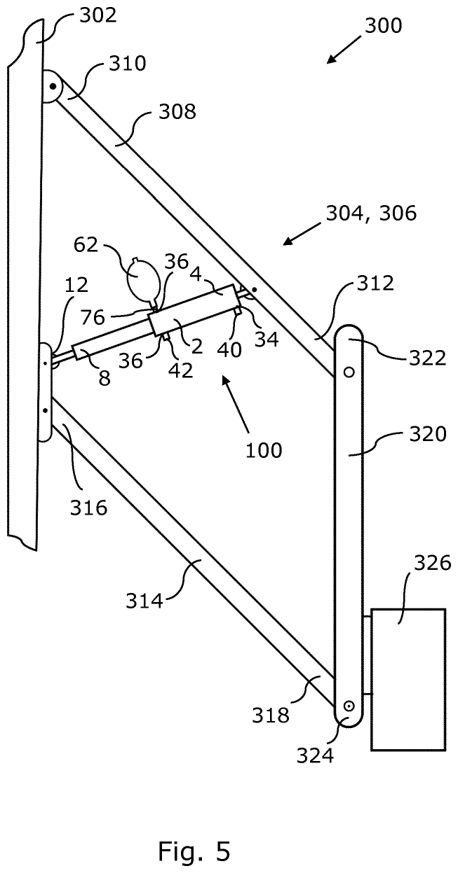

In FIG. 5 is illustrated one application of the hydraulic actuator of the first aspect of the present invention.

FIG. 5 is a schematic view illustrating an apparatus according to the third aspect of the present invention.

FIG. 5 illustrates an apparatus 300 comprising the hydraulic actuator 100 according to the first aspect of the invention. The apparatus 300 comprises a stationary part 302 and a movable part 304. The movable part 304 comprises a suspension 306 comprising a parallelogrammic frame. The parallelogrammic frame comprises a first beam 308 having a first end 310 and a second end 312, and a second beam 314 having a first end 316 and a second end 318.

The first end 310 of the first beam 308 and the first end 316 of the second beam 314 are pivotally suspending in the stationary part 302 of the apparatus 300.

Likewise, the second end 312 of the first beam 308 and the second end 318 of the second beam 314 are pivotally suspending in a suspended element 320 at a first end 322 and a second end 324 thereof, respectively.

The suspended element 320 carries a working unit which in FIG. 5 schematically is merely symbolized with the rectangular item 326.

The working unit 326 may be a movable entity in a windrower or a windrow inverter responsible for handling cut grass or straw being spread in an agricultural field. Another example of a working unit 326 may be a snow plough which is to be suspended at the front of a truck via suspension 306.

A hydraulic actuator 100 according to the first aspect of the invention is pivotally suspended between the stationary part 302 and the first beam 308 of the apparatus.

The hydraulic actuator 100 comprises a first connector 40 arranged in opening 34 for supplying hydraulic pressure into a first compartment 28 of the interior 20 of the barrel 2.

A second connector 42 arranged in opening 36 allows supplying a hydraulic pressure into the third compartment 32 of the interior 20 of the barrel 2.

Also included in the hydraulic actuator is a hydraulic accumulator 62 which is in fluid connection with the third compartment 32 of the interior 20 of the barrel 2 via connector 76.

Upon application of a hydraulic pressure into the first compartment 28 of the interior 20 of the barrel 2 of the hydraulic actuator 100, the suspended element 320 with its associated working unit 326 are being lifted. This represents a non-working position for the suspended element 320 and the working unit 326.

In a work position the suspended element 320 is lowered to the extent that the working unit touches the ground and the pressure supplied to the first compartment 28 of the interior 20 of the barrel 2 is set to “flotation pressure”, allowing hydraulic fluid to flow freely in and out of the first compartment 28 of the interior 20 of the barrel 2. Subsequently, the hydraulic pressure supplied to the third compartment 32 of the interior 20 of the barrel 2 of the hydraulic actuator is increased until the suspended element 320 and its associated working unit 326 starts to be lifted again. Then, the hydraulic pressure supplied to the third compartment 32 of the interior 20 of the barrel 2 is lowered a little and kept static. In this position the suspended element 320 with its associated working unit 326 are in a mode in which they are allowed to be dragged over the surface of the ground and yet being allowed to be raised and lowered a certain distance commensurate with an downwardly or upwardly directing force acting on the working unit 326.

Upon upholding a static hydraulic pressure in the third compartment 32 of the interior 20, via the hydraulic accumulator 62, the hydraulic pressure in the hydraulic accumulator 62 will provide some lifting force to the working unit 326, while still allowing the working unit 326 to be displaced in a vertical direction.

Depending on the exact geometry of the suspension 300 and/or the movable part 304 it is possible to attain a suspension in which one can obtain essentially a constant lifting force as encountered by the working unit 326 within a predefined range of working heights. Such a working height may in the general case be 10-120 cm or more, such as 20-110 cm, for example 30-100 cm, e.g. 40-90 cm, such as 50-80 cm or 60-70 cm.

In this respect an essentially constant lifting force as encountered by the working unit 326 within a predefined working height shall be construed to mean having an effective weight varying within a range of 1-30%, such as 2-25%, e.g. 3-24%, such as 4-23%, for example 5-22%, e.g. 6-21%, such as 7-20%, e.g. 8-19%, for example 9-18%, such as 10-17%, for example 11-16%, e.g. 12-15% or 13-14% within that working height.

The principle of the suspension 300 illustrated in FIG. 5 can advantageous be used with snow ploughs to be suspended at the front of a truck, windrowers and windrow inverters and other type of working units which are configured to be slit over the ground in a working mode.

It should be understood that all features and achievements discussed above and in the appended claims in relation to one aspect of the present invention and embodiments thereof apply equally well to the other aspects of the present invention and embodiments thereof.

### LIST OF REFERENCE NUMERALS

2 Barrel
4 Axial cap end of barrel
6 Axial head end of barrel
8 Plunger piston
10 First axial end of plunger piston
12 Second axial end of plunger piston
14 Loose piston
16 First axial surface of loose piston
18 Second axial surface of loose piston
20 Interior of barrel
22 Piston end element
24 First surface of piston end element
26 Second surface of piston end element
28 First compartment of interior of barrel
30 Second compartment of interior of barrel
32 Third compartment of interior of barrel
34 First opening for hydraulic pressure at axial cap end of barrel
36 Second opening for hydraulic pressure
38 Cylindrical element arranged between two axial ends of plunger piston
40 First hydraulic connector at axial cap end of barrel
42 Second hydraulic connector at open head end of barrel
54 Seal at head end of barrel
56 Contact surface of plunger piston
58 Guide at piston end element of plunger piston
60 Interior surface of barrel
62 Hydraulic accumulator
64,66 Channels providing fluid connectivity between second compartment and third compartment of interior of barrel
70,72 Connecting means
74 Cylindrical surface of plunger piston
76,78 Connector for hydraulic pressure
80 Hydraulic pressure gauge
100 Hydraulic actuator
200 Hydraulic circuit
202 Hydraulic pump
204 Reservoir of hydraulic liquid
206 Hydraulic valve
208,210 Hydraulic hose
212,214 Hydraulic hose
216 Hydraulic hose
218 Lever of hydraulic valve
300 Apparatus
302 Stationary part of apparatus
304 Movable part of apparatus
306 Suspension of apparatus
308 First beam of movable part
310 First end of first beam of movable part
312 Second end of first beam of movable part
314 Second beam of movable part
316 First end of second beam of movable part
318 Second end of second beam of movable part
320 Suspended element
322 First end of suspended element
324 Second end of suspended element
326 Working unit of suspension

1. A hydraulic actuator comprising:
a barrel comprising a closed axial cap end and an open axial head end;
a plunger piston comprising a first axial end and a second axial end;
a loose piston having a first axial surface and a second axial surface,
wherein the plunger piston is being arranged in an interior of the barrel at the open axial head end thereof in such a way that the first axial end of the plunger piston is arranged within the interior of the barrel and in such a way that the second axial end of the plunger piston extends axially out of the open axial head end of the barrel,
wherein the plunger piston at the first axial end thereof comprises a piston end element having a first surface pointing towards the closed axial cap end of the barrel and a second surface pointing towards the open head end of the barrel,
wherein the piston end element has dimensions in a direction perpendicular to an axial direction of the plunger piston which corresponds to an internal dimension, in a same direction, of the barrel,
wherein the loose piston is arranged within the interior of the barrel between the closed axial cap end of the barrel and the first surface of the piston end element, thereby defining a first compartment and a second compartment in the interior of the barrel, wherein the first compartment is confined between the axial cap end of the barrel and the first axial surface of the loose piston, and wherein the second compartment is confined between the second axial surface of the loose piston and the first surface of the piston end element,
wherein the interior of the barrel comprises a third compartment confined between the second surface of the piston end element and the open axial head end of the barrel,
wherein the barrel at the axial cap end thereof comprises a first opening for providing a hydraulic pressure into the first compartment of the interior of the barrel,
wherein the hydraulic actuator comprises a second opening for providing a hydraulic pressure into the second compartment or into the third compartment of the interior of the barrel,
wherein the hydraulic actuator is configured in such a way that the second compartment of the interior of the barrel is being in fluid connection with the third compartment of the interior of the barrel, and
wherein the hydraulic actuator further comprises a hydraulic accumulator in fluid connection with the second compartment or the third compartment of the interior of the barrel.

2. The hydraulic actuator according to claim 1, wherein the plunger piston comprises a cylindrical element between the second surface of the piston end element and the second axial end thereof, wherein a dimension of the cylindrical element in a direction perpendicular to an axial direction of the plunger piston is smaller than a dimension, in the same direction, of the piston end element.

3. The hydraulic actuator according to claim 1, wherein the second opening is arranged at an axial head end of the barrel, thereby allowing providing a hydraulic pressure into the third compartment of the interior of the barrel.

4. The hydraulic actuator according to claim 1, wherein the second opening is arranged at the second axial end of the plunger piston and wherein the plunger piston is provided with a channel connecting the second opening with the first surface of the piston end element, thereby allowing providing a hydraulic pressure into the second compartment of the interior of the barrel via the plunger piston.

5. The hydraulic actuator according to claim 1, further comprising a first connector for connecting a hydraulic hose, wherein the first connector is arranged in the first opening, thereby allowing application of a first hydraulic pressure into the first compartment of the interior of the barrel; or further comprising a second connector for connecting a hydraulic hose, wherein the second connector is being arranged in the second opening, thereby allowing application of a second hydraulic pressure into the second compartment and/or the third compartment of the interior of the barrel.

6. The hydraulic actuator according to claim 1, wherein the open axial head end of the barrel comprises one or more seals, sealing the space between the barrel and the plunger piston.

7. The hydraulic actuator according to claim 1, wherein the first axial end of the plunger piston is provided with one or more guides, guiding its displacement along the interior surface of the barrel.

8. The hydraulic actuator according to claim 1, wherein the loose piston is configured in a way, inter alia by adaptation of its dimensions, so as to ensure that there is no fluid connection between the first compartment and the second compartment of the interior of the interior of the barrel.

9. The hydraulic actuator according to claim 1, wherein the hydraulic accumulator is spring loaded or loaded via compressed gas.

10. The hydraulic actuator according to claim 1, wherein the hydraulic accumulator is in fluid connection with the second compartment or the third compartment of the interior of the barrel via the second opening for hydraulic pressure.

11. The hydraulic actuator according to claim 1, wherein the fluid connection between the second compartment and the third compartment of the interior of the barrel is provided by one or more channels arranged at the piston end element; such as in the form of channels extending between the first surface of the piston end element and a cylindrical surface of the plunger piston; or in the form of channels being arranged at a circumference of the piston end element, and connecting the second compartment with the third compartment.

12. The hydraulic actuator according to claim 1, wherein an area of a projection of the first surface of the piston end element onto a plane perpendicular to an axial direction of the plunger piston is greater than an area of a projection of the second surface of the piston end element onto the same plane.

13. The hydraulic actuator according to claim 1, wherein the actuator, at its two opposite axial ends, comprises a connector for fixing the actuator, at the two opposite axial ends thereof, to two different entities.

14. (canceled)

15. A hydraulic circuit comprising:
a hydraulic actuator according to claim 1;
a hydraulic pump;
a reservoir of hydraulic liquid;
one or more hydraulic valves; and
a plurality of hydraulic hoses.

16. The hydraulic circuit according to claim 15, further comprising a hydraulic accumulator being in fluid connection with the second compartment or the third compartment of the interior of the barrel of the hydraulic actuator;
wherein the hydraulic actuator, the hydraulic pump, the reservoir of hydraulic liquid, and the one or more hydraulic valves are connected with hydraulic hoses in a way that allows:
i) dynamically applying a hydraulic pressure to the first compartment of the barrel, thereby displacing the loose piston up against the first surface of the piston end element and subsequently effecting an expansion of the plunger piston relative to the barrel;
ii) dynamically applying a hydraulic pressure to the second compartment or the third compartment of the barrel, thereby allowing hydraulic fluid to flow from the third compartment into the second compartment of the interior of the barrel; or thereby allowing hydraulic fluid to flow from the second compartment into the third compartment of the interior of the barrel; thereby displacing the loose piston towards the axial cap end of the barrel; and thereby effecting an expansion of the plunger piston, relative to the barrel,
iii) upholding a static hydraulic pressure in the second compartment or the third compartment of the barrel and thereby, by virtue of the hydraulic accumulator, providing a force to the plunger piston, in an axial direction out of the barrel.

17. An apparatus comprising a stationary part and a movable part, wherein the movable part is mechanically connected to the stationary part via a suspension;
wherein the suspension comprises an actuator according to claim 1;
wherein one axial end of the actuator is connected to the stationary part of the apparatus; and wherein an opposite axial part of the actuator is connected to the moveable part of the apparatus.

18. (canceled)

19. The apparatus according to claim 17, wherein the stationary part and the movable part are configured, in relation to each other, in such a way that an expansion of the hydraulic actuator corresponds to a lift, against the action of gravity, of the movable part in relation to the stationary part.

20. The apparatus according to claim 17, wherein the apparatus comprises a working unit which is mechanically connected to the movable part.

21. The apparatus according to claim 17, wherein the apparatus is selected from the group comprising snow ploughs to be suspended at the front of a truck; and windrowers, and windrow inverters.

22. (canceled)

23. (canceled)
